(19) United States
(12) Patent Application Publication
(10) Pub. No.: US 2008/0018839 A1
(43) Pub. Date: Jan. 24, 2008

(54) Transflective liquid crystal display device

(75) Inventors: Chien-Chung Kuo, Feng Yuan City (TW); Yi-Fan Chen, Tainan City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/640,204

(22) Filed: Dec. 18, 2006

(30) Foreign Application Priority Data
Jul. 21, 2006 (TW) 095126636

(51) Int. Cl. G02F 1/1335

(52) U.S. Cl. 349/114

(57) ABSTRACT

A transflective liquid crystal display device includes a plurality of picture elements. Each picture element has a reflective region and a transmissive region, and the border between two adjoining picture elements coincides with the interface between the reflective region and the transmissive region that respectively belong to the two adjoining picture elements.

### BACKGROUND OF THE INVENTION

(a) Field of the Invention

The invention relates to a transflective liquid crystal display device having a high aperture ratio.

(b) Description of the Related Art

FIG. 1 shows a plan view illustrating a conventional transflective liquid crystal display device 100. Referring to FIG. 1, a plurality of gate lines 102 are arranged extending in a horizontal direction, and a plurality of data lines 104 are arranged extending in a vertical direction, with each two gate lines 102 intersected with two data lines 104 to define a block pixel area within which a red sub-pixel RP, a green sub-pixel GP, or a blue sub-pixel BP is formed. Each sub-pixel includes both a reflective region Re that reflects ambient light and a transmissive region Tr that transmits backlight.

FIG. 2 shows a cross-section taken along line A-A′ in FIG. 1. Referring to FIG. 2, part pixel area of each sub-pixel is provided with a reflective electrode 106 made from conductive metallic films to form the reflective region Re, while the remaining area is provided with a transparent electrode 108 made from transparent conductive films to form the transmissive region Tr. When.represents a wavelength of light, .n represents birefringence of liquid crystal, dr is the cell gap in the reflective region Re, and dt is the cell gap in the transmissive region Tr, the intensity of reflected light in the reflective region Re becomes maximum when the product .n×dr (phase difference) equals ./4. Relationship between the product .n×dr and the intensity of reflection is shown in FIG. 3A. In comparison, the intensity of transmitted light in the transmissive region Tr becomes maximum when the product .n×dt equals ./2. Relationship between the product .n×dt and the intensity of transmission is shown in FIG. 3B. Hence, as shown in FIG. 2, a flattened layer 110 is additionally formed in the reflective region Re, and the reflective electrode 106 is formed on the flattened layer 110 to allow different cell gaps for the reflective region Re and the transmissive region Tr, so that light propagates in the reflective region Re and in the transmissive region Tr may achieve the same phase difference.

Since each sub-pixel that corresponds to a red color filter 112R, green color filter 112G, or blue color filter 112B is an independent addressable unit, each pixel area of the sub-pixel is surrounded by an inter-pixel region having a width d that insulates adjacent sub-pixels from each other. Under the circumstance, on the flattened layer 110 two reflective electrodes 106a and 106b that respectively belong to two adjoining pixels RP and GP are spaced apart by an interval d. However, since the inter-pixel region where no electrode is formed does not contribute to the screen display, a larger ratio of the inter-pixel region apparently decreases the aperture ratio of a transflective liquid crystal display device.

### BRIEF SUMMARY OF THE INVENTION

Hence, an object of the invention is to provide a transflective liquid crystal display device having a high aperture ratio.

According the invention, the transflective liquid crystal display device includes a plurality of picture elements. Each picture element has a reflective region and a transmissive region, and the border between two adjoining picture elements coincides with the interface between the reflective region and the transmissive region that respectively belong to the two adjoining picture elements. The reflective electrode and the transparent electrode are formed at different heights on a substrate, and the signal lines are provided underneath the reflective electrode within the reflective region.

Through the design of the invention, since the reflective electrode and the transparent electrode are formed at different heights, the height difference automatically insulates adjoining picture elements from each other when the border between two adjoining picture elements is designed to coincide with the interface between the reflective region and the transmissive region that respectively belong to different picture elements. Hence, the inter-pixel region exists in the conventional design can be eliminated to increase the active display area and improve the aperture ratio as a result.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a plan view illustrating a conventional transflective liquid crystal display device.

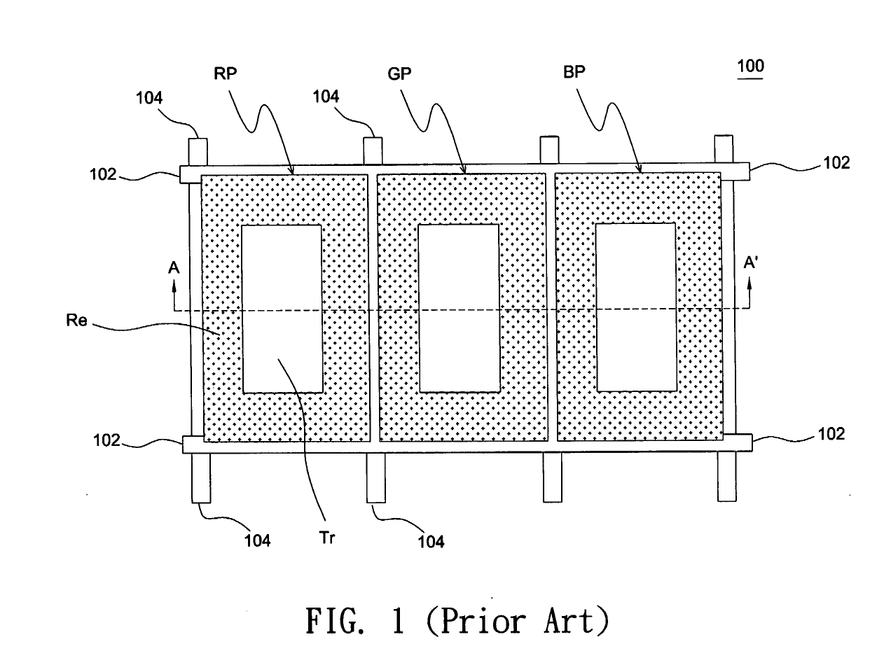

FIG. 2 shows a cross-section taken along line A-A′ in FIG. 1.

FIG. 3A shows a curve diagram illustrating relationship between the phase difference .n×dr and the intensity of reflected light in the reflective region.

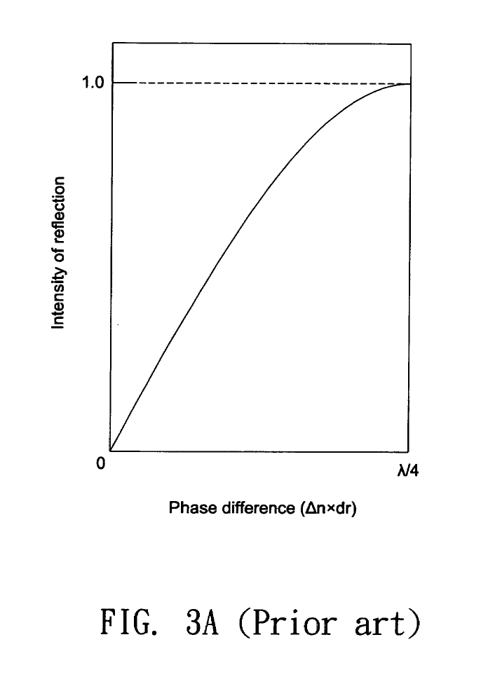

FIG. 3B shows a curve diagram illustrating relationship between the phase difference .n×dt and the intensity of transmitted light in the transmissive region.

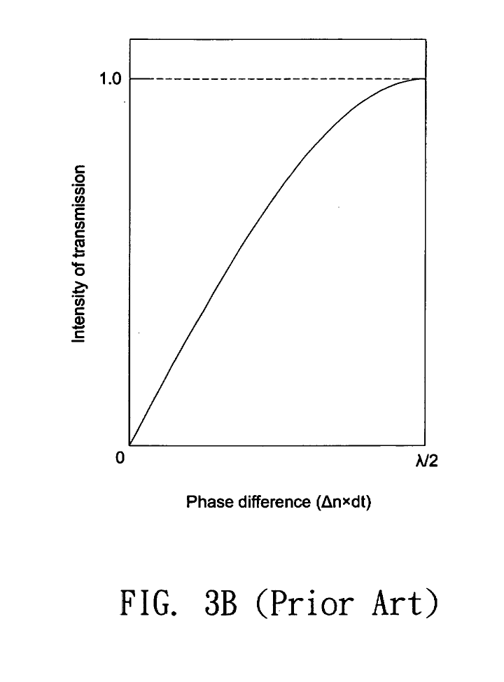

FIG. 4 shows a plan view illustrating a transflective liquid crystal display device according to an embodiment of the invention.

FIG. 5 shows a cross-section taken along line B-B′ in FIG. 4.

FIG. 6 shows a plan view illustrating another embodiment of the invention.

FIG. 7 shows a plan view illustrating another embodiment of the invention.

FIG. 8 shows a plan view illustrating another embodiment of the invention.

FIG. 9 shows a plan view illustrating another embodiment of the invention.

FIG. 10 shows a plan view illustrating another embodiment of the invention.

### DETAILED DESCRIPTION OF THE INVENTION

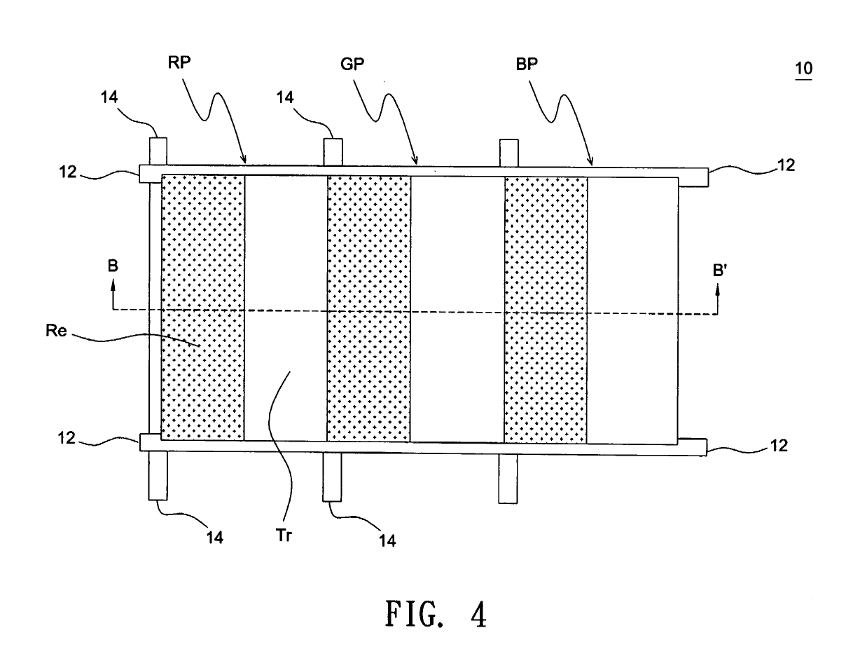

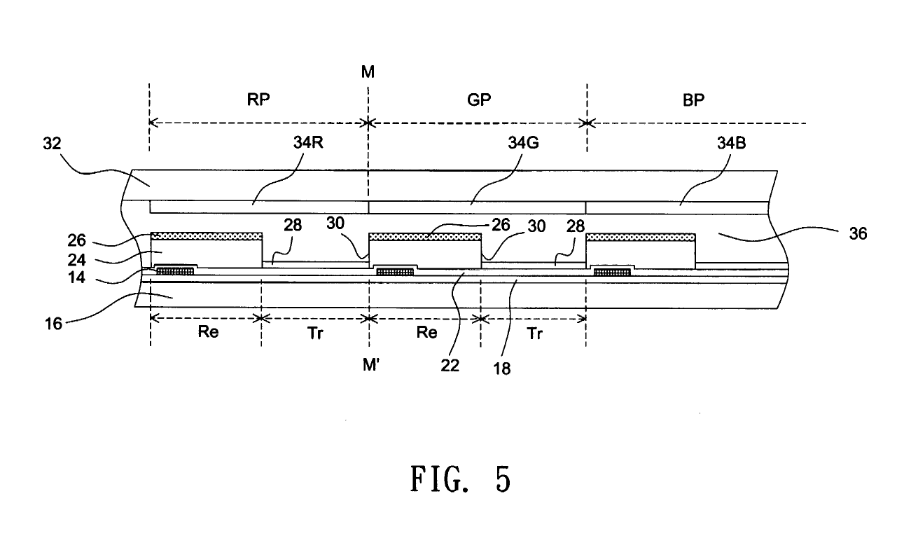

FIG. 4 shows a plan view illustrating a transflective liquid crystal display device 10 according to an embodiment of the invention. FIG. 5 shows a cross-section taken along line B-B′ in FIG. 4. Referring to FIG. 4, a plurality of gate lines 12 are arranged extending in a horizontal direction, and a plurality of data lines 14 are arranged extending in a vertical direction, with each two gate lines 12 intersected with two data lines 14 to define a block pixel area. Note that, in this embodiment, the transflective liquid crystal display device 10 is exemplified as a color active matrix type, so that an independent addressable picture element of the display device 10 is a red, green, or blue sub-pixel spread on the block pixel area. Also, each of the sub-pixels RP, GP and BP includes a reflective region Re and a transmissive region Tr.

FIG. 5 clearly illustrates the sectional structure of a sub-pixel. On the transparent substrate 16, gate lines 12 (not shown) are formed, and a gate insulation layer 18 is formed to cover the gate lines 12 and serves as an interlayer insulating film between the gate lines 12 and the data lines 14. The data lines 14 are formed on the gate insulation layer 18, and a passivation layer 22 is formed on the gate insulation layer 18 and covers the data lines 14. In each pixel area, a flattened layer 24 is formed on the passivation layer 22 within part of the pixel area, and a plurality of reflective electrodes 26 are formed on the flattened layer 24 to form the reflective region Re. A plurality of transparent electrodes 28 are formed on the passivation layer 22 within the remaining pixel area where no flattened layer 24 is provided to form the transmissive region Tr. The reflective electrode 26 may be made from conductive metallic films, and the transparent electrode 28 may be made from transparent conductive films such as indium tin oxide (ITO), indium zinc oxide (IZO), or aluminum zinc oxide (AZO) films. Further, the flattened layer 24 may be made from insulation materials.

Since the reflective electrode 26 is formed on the flattened layer 24 to allow different cell gaps for the reflective region Re and the transmissive region Tr, light propagates in the reflective region Re and the transmissive region Tr may achieve the same phase difference. In that case, a drop surface 30 is formed due to the height difference between a reflective electrode 26 and a transparent electrode 28 that are adjacent to each other. Further, on the transparent substrate 32, a red, a green and a blue filters 34R, 34G and 34B are formed corresponding to the red, green, and blue sub-pixels RP, GP and BP, respectively. A liquid crystal layer 36 is interposed between the transparent substrate 16 and the transparent substrate 32.

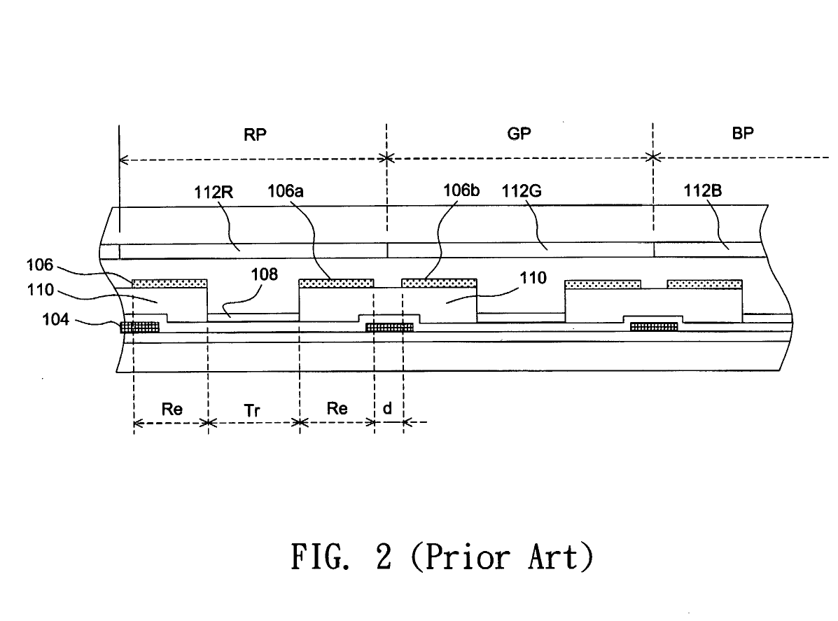

As shown in FIG. 5, the border between two adjoining sub-pixels (such as the border M-M′ between the red sub-pixel RP and the green sub-pixel GP) coincides with the interface (the drop surface 30) between the transmission region Tr of the red sub-pixel RP and the reflective region Re of the green sub-pixel GP. Further, the metallic signal lines such as data lines 14 are provided underneath the reflective electrode 26 within the reflective region Re. Through the design of the invention, since the reflective electrode 26 and the transparent electrode 28 are formed at different heights, the height difference automatically insulates adjoining picture elements from each other when the border between two adjoining picture elements is designed to coincide with the interface between the reflective region and the transmissive region that respectively belong to the two adjoining picture elements. Hence, the inter-pixel region exists in the conventional design (shown in FIG. 2) can be eliminated to increase the active display area and improve the aperture ratio as a result. According to the experiment result proposed by the inventor, the aperture ratio achieved by the invention increases by 5% or more when compared with that of the conventional design where the inter-pixel region requires a width of 5 um.

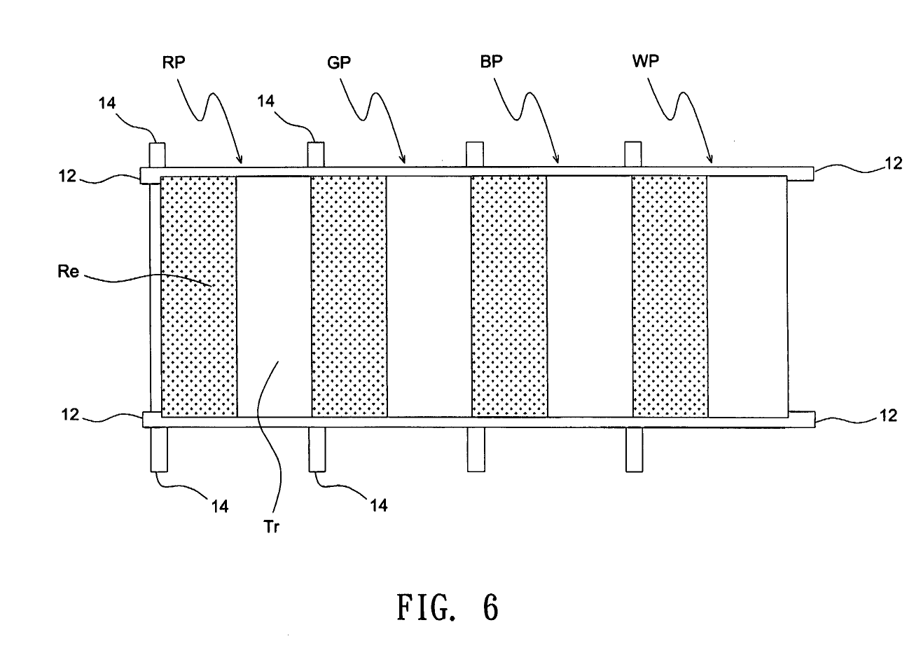

Note that the design of the invention is not limited to a RGB three-color transflective LCD. Alternatively, it may be also applied in a RGBW four-color transflective LCD having red, green, blue and white sub-pixels RP, GP, BP and WP, as shown in FIG. 6.

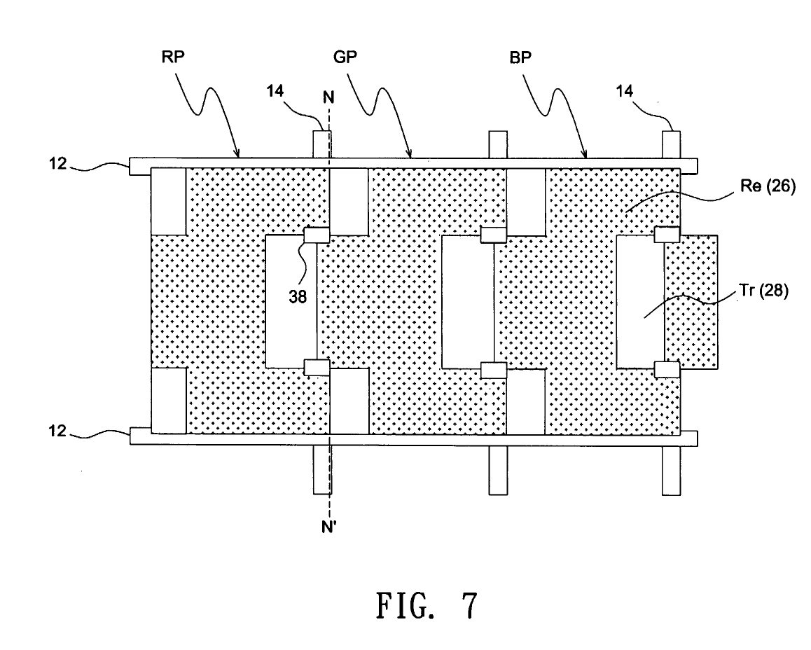

In the above embodiment, the sub-pixels are arranged as multiple horizontal rows, and in each row the block area of one sub-pixel in the vicinity of the border is spread with an entire reflective region Re or an entire transmissive region Tr. However, the distribution of the reflective and transmissive regions in one sub-pixel is not limited. For instance, as shown in FIG. 7, the block area of the sub-pixel RP in the vicinity of the border N-N′ between two adjoining sub-pixels RP and GP is spread with alternate reflective region Re and transmissive region Tr, which are complementary to the alternate transmissive region Tr and reflective region Re of the sub-pixel GP in the vicinity of the border N-N′ so that each of the three sections of the border N-N′ may coincide with the interface between a reflective region Re and a transmissive region Tr. Note that, in this embodiment, small cut off portions 38 where no electrode is formed is provided to eliminate possible connection between two distinct sub-pixels.

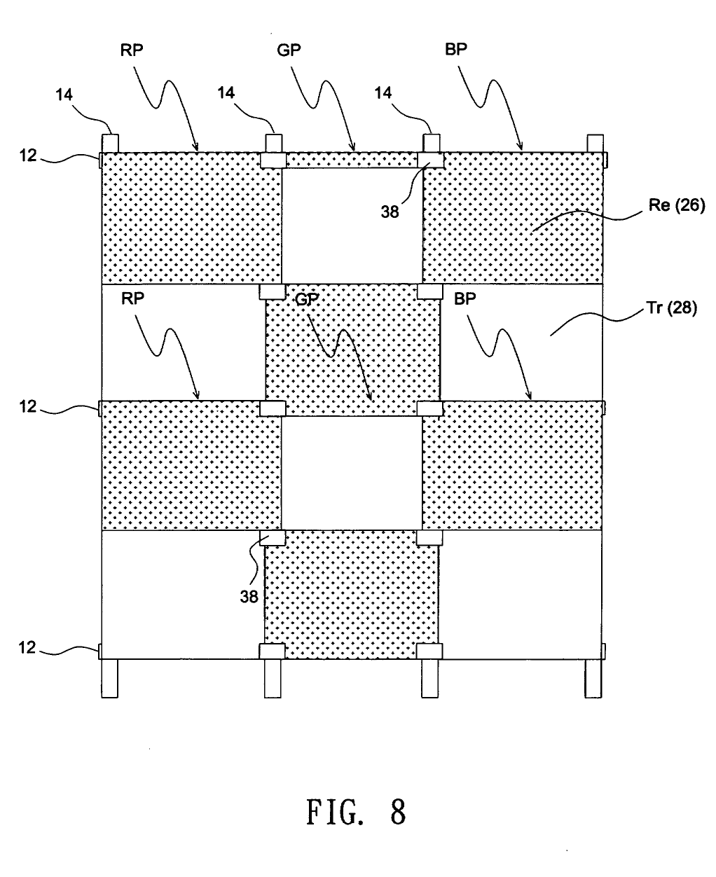

FIG. 8 shows a plan view illustrating another embodiment of the invention. In this embodiment, the red, green and blue sub-pixels RP, GP and BP are alternately arranged both in the horizontal and vertical directions, and the border between two adjoining sub-pixels in the horizontal direction or between two adjoining sub-pixels in the vertical direction coincides with the interface between a reflective region Re and a transmissive region Tr. Further, the gate lines 12 and the data lines 14 are formed within the reflective region Re (i.e. between the reflective electrode 26 and the transparent substrate 16). Therefore, the inter-pixel regions between two adjoining sub-pixels arranged in the horizontal direction (inter-pixel region superposed on the data lines 14) and between two adjoining sub-pixels arranged in the vertical direction (inter-pixel region superposed on the gate lines 12) are both eliminated to further increase the aperture ratio. Note that, in this embodiment, small cut off portions 38 where no electrode is formed is also provided to eliminate possible connection between two distinct sub-pixels.

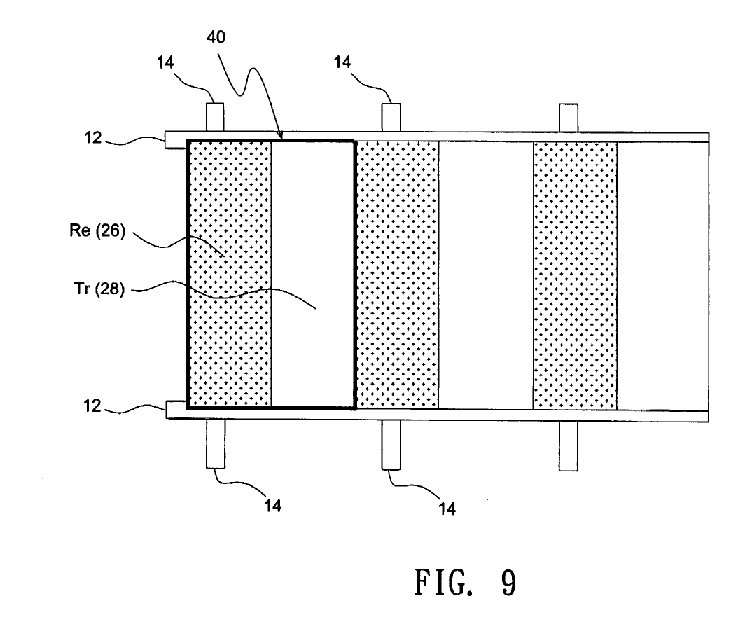

FIG. 9 shows a plan view illustrating another embodiment of the invention. As shown in FIG. 9, each two adjacent gate lines 12 are intersected with two data lines 14 to define a block pixel area, and bold solid lines indicate the distribution area of a pixel electrode structure 40 that includes both a reflective electrode 26 and a transparent electrode 28; that is, the active display area of a sub-pixel. In this embodiment, the pixel electrode structure 40 is not distributed within the block area but shifted for a certain distance along the extending direction of the gate line 12, so that the pixel electrode structure 40 is partially outside the block area and straddles the data line 14. Further, the border between two adjoining sub-pixels coincides with the interface between the reflective electrode 26 and the transparent electrode 28 that respectively belong to the two adjoining sub-pixels.

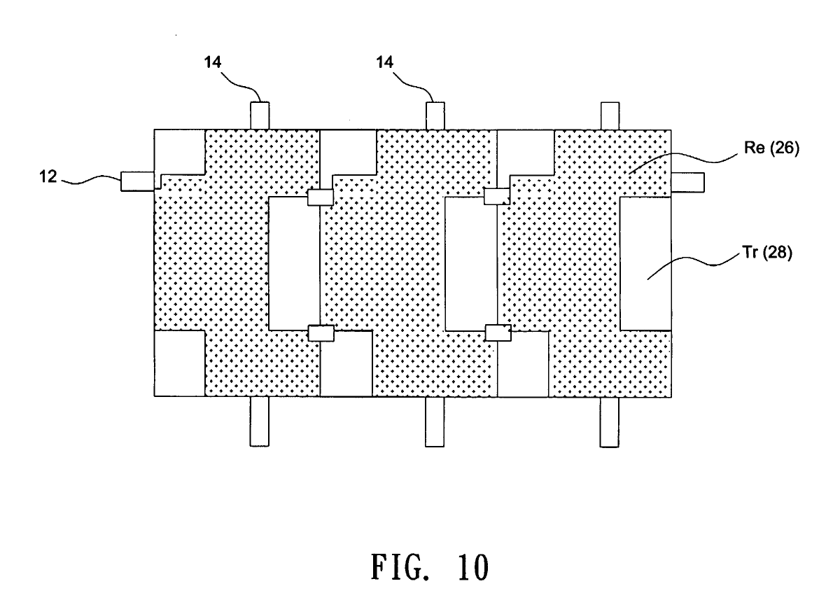

Alternatively, as shown in FIG. 10, the pixel electrode structure 40 is not distributed within the block area but shifted for a certain distance along the extending directions of both the gate line 12 and the data line 14, so that the pixel electrode structure 40 is outside the block area and straddles both the gate line 12 and the data line 14. The misalignment arrangement of the pixel electrode structure 40 in relation to the block pixel area such as shown in FIGS. 9 and 10 may further improve the aperture ratio.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A transflective liquid crystal display device comprises a plurality of picture elements, each picture element having a reflective region and a transmissive region, and the border between two adjoining picture elements coinciding with the interface between the reflective region and the transmissive region that respectively belong to the two adjoining picture elements.

2. The transflective liquid crystal display device as claimed in claim 1, wherein the pixel area in the vicinity of the border of either of the two adjoining picture element is spread with an entire reflective region or an entire transmissive region.

3. The transflective liquid crystal display device as claimed in claim 1, wherein the pixel area in the vicinity of the border of either of the two adjoining picture element is spread with alternate reflective region and transmissive region.

4. The transflective liquid crystal display device as claimed in claim 1, wherein the picture elements include red, green, and blue sub-pixels.

5. The transflective liquid crystal display device as claimed in claim 1, wherein the picture elements include red, green, blue and white sub-pixels.

6. The transflective liquid crystal display device as claimed in claim 1, wherein each picture element includes a plurality of signal lines, and the signal lines are formed within the reflective region.

7. A transflective liquid crystal display device, comprising:
a first and a second substrates facing to each other;
a liquid crystal layer interposed between the first and the second substrates; and
a plurality of pixel electrode structures formed on the second substrate, each of which is provided corresponding to a picture element of the transflective liquid crystal display device and comprises a reflective electrode and a transparent electrode adjacent to each other;
wherein the reflective electrode and the transparent electrode are formed at different heights on the second substrate to form a plurality of drop surfaces that construct the border of two adjoining picture elements.

8. The transflective liquid crystal display device as claimed in claim 7, further comprising a flattened layer formed on the second substrate, wherein the reflective electrode is formed on the flattened layer to result in a height difference between the reflective electrode and the transparent electrode.

9. The transflective liquid crystal display device as claimed in claim 7, wherein the reflective electrode is made from metallic films, and the transparent electrode is made from indium tin oxide (ITO), indium zinc oxide (IZO), or aluminum zinc oxide (AZO) films.

10. The transflective liquid crystal display device as claimed in claim 7, further comprising a plurality of signal lines formed between the reflective electrode and the second substrate.

11. The transflective liquid crystal display device as claimed in claim 7, further comprising a plurality of gate lines and data lines formed on the second substrate, with each two gate lines intersected with two data lines to define a block area within which the pixel electrode structure is spread.

12. The transflective liquid crystal display device as claimed in claim 7, further comprising a plurality of gate lines and data lines formed on the second substrate, with each two gate lines intersected with two data lines to define a block area, and each pixel electrode structure being positioned partially outside the block area and straddling a gate line or a data line.

13. The transflective liquid crystal display device as claimed in claim 7, further comprising a plurality of gate lines and data lines formed on the second substrate, with each two gate lines intersected with two data lines to define a block area, and each pixel electrode structure being positioned partially outside the block area and straddling a gate line and a data line.

14. A transflective liquid crystal display device, comprising:
a first and a second substrates facing to each other;
a liquid crystal layer interposed between the first and the second substrates;
a plurality of first signal lines formed on the second substrate;
a first dielectric layer formed on the second substrate and covering the first signal lines;
a plurality of second signal lines formed on the first dielectric layer;
a second dielectric layer formed on the first dielectric layer and covering the second signal lines;
a flattened layer formed on part of the second dielectric layer;
a plurality of reflective electrodes formed on the flattened layer; and
a plurality of transparent electrodes formed on part of the second dielectric layer where no flattened layer is provided;
wherein the border between two adjoining picture elements of the transflective liquid crystal display device coincides with the interface between the reflective region and the transmissive region that respectively belong to the two adjoining picture elements.

15. The transflective liquid crystal display device as claimed in claim 14, wherein the first dielectric layer is a gate insulation layer and the second dielectric layer is a passivation layer.

16. The transflective liquid crystal display device as claimed in claim 14, wherein the reflective electrode is made from metallic films, and the transparent electrode is made from indium tin oxide (ITO), indium zinc oxide (IZO), or aluminum zinc oxide (AZO) films.

17. The transflective liquid crystal display device as claimed in claim 14, wherein the flattened layer is made from insulation materials.

18. The transflective liquid crystal display device as claimed in claim 14, wherein the first and the second signal lines are formed between the reflective electrode and the second substrate.

19. The transflective liquid crystal display device as claimed in claim 14, wherein each two first signal lines are intersected with two second signal lines to define a block area within which a reflective electrode together with a neighboring transparent electrode are spread.

20. The transflective liquid crystal display device as claimed in claim 14, wherein each two first signal lines are intersected with two second signal lines to define a block area, and a reflective electrode together with a neighboring transparent electrode are positioned partially outside the block area and straddles a gate line or a data line.

21. The transflective liquid crystal display device as claimed in claim 14, wherein each two first signal lines are intersected with two second signal lines to define a block area, and a reflective electrode together with a transparent electrode are positioned partially outside the block area and straddles a gate line and a data line.
